(19) United States
(12) Patent Application Publication
(10) Pub. No.: US 2007/0208696 A1
(43) Pub. Date: Sep. 6, 2007

(54) EVALUATING MATERIALIZED VIEWS IN A DATABASE SYSTEM

(76) Inventor: Louis Burger, Escondido, CA (US)

Correspondence Address: James M. Stover;Intellectual Property Section, Law Department, NCR Corporation, 1700 South Patterson Blvd., Dayton, OH, 45479-0001, US

(21) Appl. No.: 11/681,807

(22) Filed: Mar. 5, 2007

Related U.S. Application Data
(60) Provisional application No. 60/779,114, filed on Mar. 3, 2006.

(51) Int. Cl. G06F 17/30

(52) U.S. Cl. 707/2

(57) ABSTRACT

A system and method of evaluating a materialized view relating to a base table for a database system. The method includes the steps of defining a simulated materialized view for the base table within a user session and storing the definition for the simulated materialized view in computer memory such that the definition is available only within the user session. The method further includes the step of maintaining the definition(s) for one or more active materialized views relating to the base table in computer memory such that the definition(s) is/are available outside the user session. An optimizer is invoked to evaluate the simulated materialized view within the user session as if the materialized view was available outside the user session. As an additional step, a simulated materialized view is then selected on detecting a potential improvement of performance.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from a disk drive to a memory device accessible by a processor, database software is then able to examine the data to determine if it satisfies the conditions of a query.

Queries issued to the database system may be processed with a multitude of possible execution plans. Some execution plans are more cost efficient than other execution plans based on several factors including the number and size of intermediate result sets required to be constructed. Some queries are able to undergo query optimization that can enable dramatic improvements in performance in such database systems. A cost based query optimizer evaluates some or all possible execution plans for a query and estimates the cost of each plan based on resource utilization. The optimizer eliminates costly plans and chooses a relatively low cost plan.

Physical database design is an essential step in implementing a high performance database system. Even an efficient cost based query optimizer will struggle to optimize queries issued to a poorly designed database system. During the design process, users must make choices regarding the physical characteristics of relational tables and columns. Such choices typically include indexes, partitioning strategies and materialized views. A materialized view is an advanced indexing structure that stores derived data usually in the form of pre-joined or pre-aggregated data. Like other indexes, they are automatically maintained by the system during updates. They can dramatically improve performance by eliminating the need to perform certain joins or aggregations at query execution time. In addition, materialized views can be used to provide an alternative primary index for all or a portion of the data of a table.

Because user workloads and data volumes change over the course of time, users must periodically tune the physical design of a database system. Experienced users will often have several promising design ideas but will be reluctant to try out these ideas on a production system for fear of negatively impacting system performance. Such negative impacts include resources to build the index or materialized view and resources to maintain the index or materialized view during data loads or SQL updates. Materialized views are inherently more complex and more difficult to design than simple or traditional indexes.

What is needed is a method of evaluating materialized views in a database system without impacting unduly on the system. It would be particularly desirable to provide a feature such as a “what if” feature for users to perform investigations and experiments.

### SUMMARY

Described below is a method of evaluating a materialized view relating to a base table for a database system. The method includes the steps of defining a simulated materialized view for the base table within a user session and storing the definition for the simulated materialized view in computer memory such that the definition is available only within the user session. The method further includes the step of maintaining the definition(s) for one or more active materialized views relating to the base table in computer memory such that the definition(s) is/are available outside the user session. An optimizer is invoked to evaluate the simulated materialized view within the user session as if the materialized view was available outside the user session.

Also described is a method of selecting a materialized view relating to a base table for a database system. Once again, a simulated materialized view is defined for the base table within a user session, the definition is stored for the simulated materialized view in computer memory such that the definition is available only within the user session, and the definition(s) for one or more active materialized views relating to the base table are maintained in computer memory such that the definition(s) is/are available outside the user session. An optimizer is invoked to evaluate the simulated materialized view within the user session as if the materialized view was available outside the user session. The simulated materialized view is then selected on detecting a potential improvement of performance.

Also described below are systems and computer programs for evaluating a materialized view relating to a base table for a database system, and for selecting a materialized view relating to a base table for a database system.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flow chart of the parser of FIG. 2.

### DETAILED DESCRIPTION

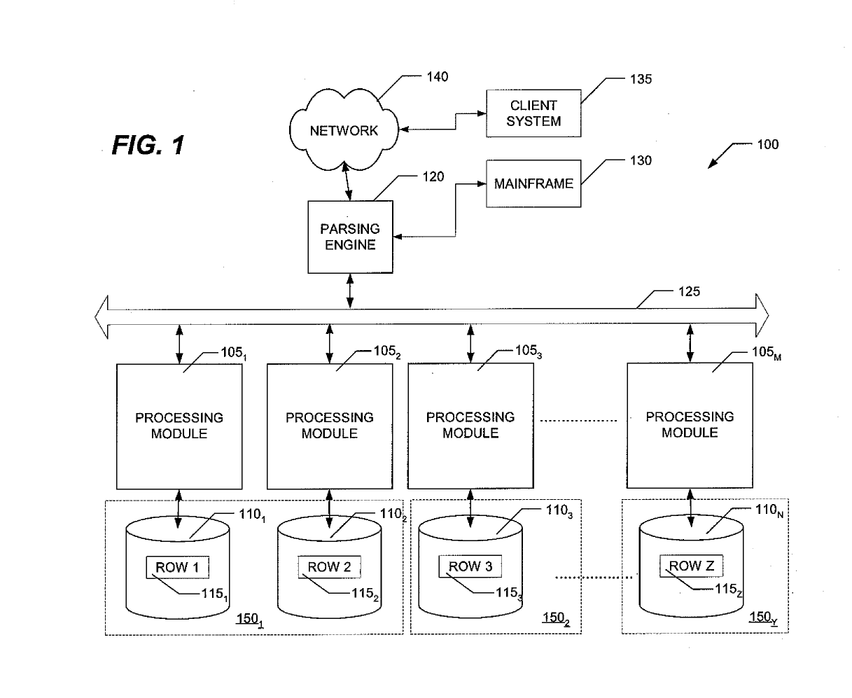

FIG. 1 shows an example of a database system 100, such as a Teradata Active Data Warehousing System available from NCR Corporation. Database system 100 is an example of one type of computer system in which the techniques of evaluating materialized views are implemented. In computer system 100, vast amounts of data are stored on many disk-storage facilities that are managed by many processing units. In this example the data warehouse 100 includes a Relational Database Management System (RDMS) built upon a Massively Parallel Processing (MPP) platform.

Other types of database systems, such as object-relational database management systems (ORDMS) or those built on symmetric multi-processing (SMP) platforms, are also suited for use here.

The database system 100 includes one or more processing modules 105_{1 . . . M} that manage the storage and retrieval of data in data storage facilities 110_{1 . . . N}. Each of the processing modules 105_{1 . . . M} manages a portion of a database that is stored in a corresponding one of the data storage facilities 110_{1 . . . N}. Each of the data storage facilities 110_{1 . . . N} includes one or more disk drives.

The system stores data in one or more tables in the data storage facilities 110_{1 . . . N}. The rows 115_{1 . . . Z} of the tables are stored across multiple data storage facilities 110_{1 . . . N} to ensure that the system workload is distributed evenly across the processing modules 105_{1 . . . M}. A parsing engine 120 organizes the storage of data and the distribution of table rows 115_{1 . . . Z} among the processing modules 105_{1 . . . M}. The parsing engine 120 also coordinates the retrieval of data from the data storage facilities 110_{1 . . . N} over network 125 in response to queries received from a user at a mainframe 130 or a client computer 135 connected to a network 140. The database system 100 usually receives queries and commands to build tables in a standard format, such as SQL.

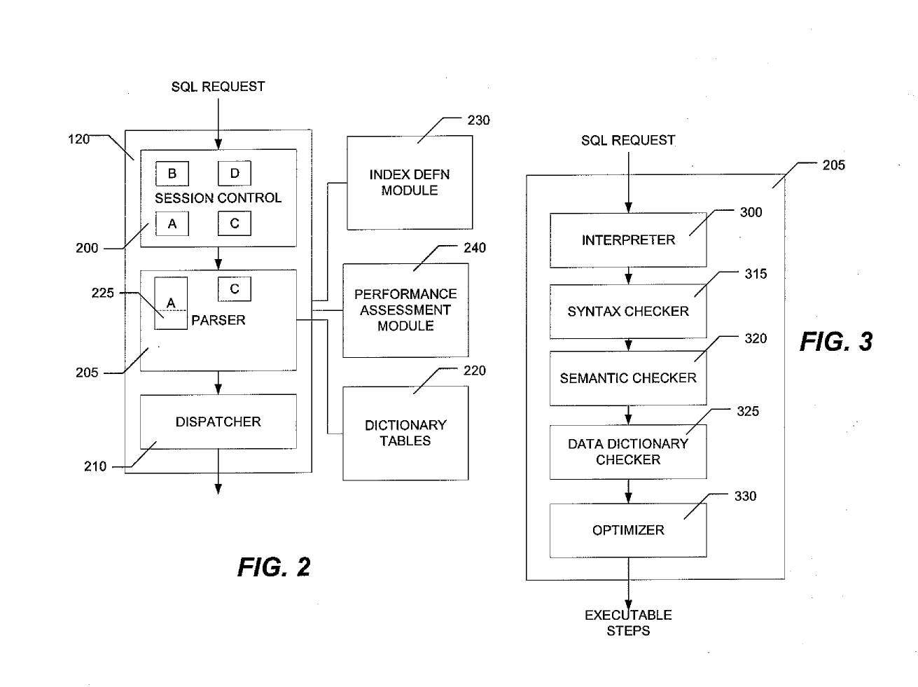

Referring to FIGS. 2 and 3, in one example system, the parsing engine 120 is made up of three components: a session control 200, a parser 205, and a dispatcher 210. The session control 200 provides a log on and log off function. It accepts a request for authorization to access the database, verifies it, and then either allows or disallows the access. Session control 200 has logged on four active sessions namely session A, session B, session C and session D. As shown in the parser 205 only session A and session C have ongoing parsing operations. Each of sessions A, B, C and D have access to active indices stored in a dictionary structure 220 indicated as a series of dictionary tables. Definitions of active indices are stored in dictionary 220 and are available to all sessions including session A and session C. Session A also has available to it a series of “what-if” indices that are stored in a session context memory structure 225. These definitions are only available to session A within a private user session and are not available to sessions B, C nor D.

The system further includes an index definition module 230 with which a user defines indexes to store in memory structure 225 and/or dictionary structure 220. The system also includes a performance assessment module 240 with which the user assesses the performance of indexes stored in memory structure 225 and/or dictionary structure 220.

Once the session control 200 allows a session to begin, a user may submit a SQL request, which is routed to the parser 205. The parser 205 interprets the SQL request (block 300).

The parser checks the request for proper SQL syntax (block 315), evaluates it semantically (block 320), and consults a data dictionary to ensure that all of the objects specified in the SQL request actually exist and the user has the authority to perform the request (block 325). Finally, the parser 205 runs an optimizer (block 330) which develops the least expensive plan to perform the request.

The query processing architecture described above for most relational database systems is divided into a compile time sub-system 120, 205 to parse and optimize the SQL request and a separate run time sub-system implemented by processing modules 105_{1 . . . M} to interpret the plan and execute the query. The execution plan generated at compile time is usually in the form of an intermediate language that describes low level steps to be performed including file retrievals, index usage, sorting, join operations and so on. In addition, portions of the execution plan include or potentially include actual machine code to perform comparisons, arithmetic and so on.

Database system 100 supports the use of materialized views. Materialized views are special tables within the database containing data derived from one or more base tables. In the Teradata system materialized views are supported using a JOIN INDEX feature. A typical syntax for defining join indexes using index definition module 230 in the Teradata system is:

CREATE JOIN INDEX <index_name> AS <query>
PRIMARY INDEX <column_list>

In the above syntax <query> is the standard SQL SELECT statement.

Optimizer 325 develops the least expensive plan to perform a request. The optimizer automatically determines whether to use an available join index in the execution plan of a given SQL query. Users are able to examine the plan chosen by the optimizer along with the estimated costs of executing that plan by using the performance assessment module 240 having features such as the Teradata Query Capture feature. Query capture is enabled by preceding a sample SQL statement with the term INSERT EXPLAIN modifier that instructs the system to capture the resulting plan and store in relational form. The query statement is not actually executed against the data and therefore no data results are returned. The plan in the form of rows is stored in a set of predefined dictionary tables which in the Teradata system is referred to as a Query Capture database.

The basic syntax for capturing a plan is:

INSERT EXPLAIN INTO <query_capture_database> AS
<query_name> <sql_statement>

A typical statement using the INSERT EXPLAIN feature is:

INSERT EXPLAIN INTO qcd AS query1
SELECT * from t1
WHERE c1 = 10 and c2 = 20

Some database systems for example database system 100 include a facility to enable users to tune physical database design by analyzing given workloads and automatically recommending indexes that would improve the response time of one or more queries. Users may wish to further validate these system generated recommendations on a production system. Alternatively, users may wish to experiment with index recommendations of their own design. In either case, database system 100 provides a special validation mode that permits users to define and evaluate the recommendation without impacting a production system.

The system provides a validation processing mode within which a user defines and evaluates a user specified index definition. When operating in validation mode, all CREATE INDEX statements issued within a user session initiated at 200 are stored as simulated definitions and are not stored in the data dictionary 220 on disk. Indexes defined during validation mode are stored in a session context memory structure 225 in computer memory such that the definitions are only available to a user within a private user session and are not available to other users of the system. Queries processed within that user session are then treated by the optimizer as if the index had been created and stored in the data dictionary. During the user session the optimizer treats all indexes defined in the private user session 225 as if they were stored in the data dictionary 220 along with other active indexes available to others. The optimizer therefore evaluates the simulated plan within the user session and optionally at least one of the active materialized views. The resulting plans for such queries can then be captured to determine if performance would be improved if the index was defined.

The design process for materialized views is often difficult because the definitions of materialized views are complex. It is also difficult to predict the potential benefit to queries and the potential impact to maintenance overhead during updates. Even experienced users typically need to test several different materialized view candidates before finding an ideal solution. Such testing is disruptive to execute on a production system.

The database system enables a user to define a materialized view or join index. This join index can then be simulated when operating in validation mode.

Join indexes defined in validation mode are not actually created and stored in the data dictionary and on disk. Nor are the join indexes populated with data. The definition of the join index defined in validation mode is instead entered into a session private context structure within a private user session. The definition is only available within the user session and is not available outside this user session. Other sessions are unaware and unaffected by it.

The system in one embodiment includes the capability to collect statistics on join indexes that have been defined in validation mode. Typical statistics generated and maintained by the system are in the form of a histogram and include min, max, mode, number of distinct values and total number of rows. These statistics are also stored for the table as a whole. As join indexes defined in validation mode are not populated with data, during the data collection process the system identifies index definitions within a user session. From the index the system determines the relevant underlying base table data and then collects statistics on the base table or base tables relating to the join index.

In another embodiment of the system, the performance assessment module 240 additionally or alternatively includes the capability for a user to estimate and capture the maintenance overhead costs associated with the join indexes that have been defined during the user session. When a plan is captured for any update related SQL statement for example INSERT, UPDATE OR DELETE, the system will automatically identify any affected join indexes that were previously created and estimate the maintenance costs. Users can then predict both the benefits to queries as well as the cost to updates thereby giving a user better information regarding the impact to the overall system workload.

Given below is an example query whose performance is of concern to a user. The user wishes to experiment with a new materialized view in the hopes of improving its performance. The user first captures the existing plan and performance for this query as follows:

INSERT EXPLAIN INTO qcd AS query_before
SELECT t1.a1, t1.b1 FROM t1,t2
WHERE t1.c1 = t2.c2

This statement invokes the query capture feature for the query called query_before representing a query prior to join index definition. The captured query plan, or rather rows of the plan, are stored in a Query Capture database called qcd.

Base tables t1 and t2 are defined as follows:

CREATE TABLE t1 (a1 integer, b1 float, c1 integer, d1
char(10) primary index (a1));
CREATE TABLE t2 (a2 integer, b2 float, c2 integer, d2
char(10), primary index (c2));

In the example below, the user experiments with a new join index whose primary index is defined on column c1 in the hopes of improving the performance of a join query. Note that base table t1 has its primary index on column a1. To do this, the user defines a join index for example “ji_on_t1” containing a subset of the columns from table t1 with an alternative primary index. This alternative primary index will potentially be used to avoid data redistribution during the join query.

The user then commences validation mode by the statement:

DIAGNOSTIC “VALIDATE INDEX” ON FOR SESSION

During validation mode the user creates the new join index as follows:

CREATE JOIN INDEX ji_on_t1 AS
SELECT a1, b1, c1 FROM t1
PRIMARY_INDEX (c1);

The above statement simulates the creation of a join index on base table t1. The join index is given the name “ji_on t1”. The three columns selected are a1, b1, and c1 and the column c1 serves as an alternative partitioning key as it appears in the PRIMARY_INDEX statement. The previously captured query labeled query_before has a join on t1.c1, in the WHERE clause of the query. The new join index defines its primary index on t1.c1.

Statistics are optionally collected on the newly defined join index during diagnostic mode as follows:

COLLECT STATISTICS USING SAMPLE ON ji_on_t1
INDEX (c1);

When executed in validation mode, the system automatically translates the user specified collection on the simulated join index to the equivalent collection on the underlying base table of the join index. In the statement above, the system will collect statistics on column t1.c1. When considering the potential usage of the join index, the optimizer in database system 100 will automatically inherit and use these statistics collected on the base table.

The user can then optionally capture the plan and costs for a query involving a join operation that would make use of the alternative partitioning of the join index defined above as follows:

INSERT EXPLAIN INTO qcd AS query_after
SELECT t1.a1, t1.b1 FROM t1, t2
WHERE t1.c1 = t2.c2;

In the statement above the user activates the query capture feature with the INSERT EXPLAIN INTO clause, storing details of the definition in Query Capture database qcd with a query called “query_after” representing a query after the join index definition.

The user may optionally capture the plan and costs for an update that would require maintenance on the simulated join index with the following statement:

INSERT EXPLAIN INTO qcd AS upd_on_t1
UPDATE t1 SET t1.b1 = t1.b1 *1.2
WHERE t1.a1 < 1000;

The user then exits the validation mode with the following command:

DIAGNOSTIC “VALIDATE INDEX” NOT ON FOR SESSION;

The above statements enable a user to activate a validation mode, create a join index that is only available to the user within a user session and to collect statistics and capture plan and costs for queries and updates relevant to the join index and the tables related to the join index. The user is then able to examine the captured plan steps and costs for the query with and without the simulated join index. This can be achieved with the following statement:

SELECT queryname, steptext, cost
FROM qcd.querysteps
WHERE queryname in (‘query_before’, ‘query_after’)
AND cost > 0;

This query retrieves “what-if” results from the Query Capture database that confirm that the user simulated index has indeed reduced the query costs by eliminating the need to redistribute t1 prior to performing the join operation. The following table shows a sample of the results returned by the above query. The results in the table show that the cost for “query_before” is 200 whereas “query_after” is 100. This can be attributed to avoiding the need to redistribute the data during the join query.

| queryname | Steptext | cost |
|---|---|---|
| query_before | Retrieve t1 and redistribute to spool 1 | 60 |
| query_before | Sort spool1 on column c1 | 40 |
| query_before | Join spool1 and t2 | 100 |
| query_after | Join t1 and t2 directly | 100 |

The maintenance costs incurred by the update can also be compared. The following query retrieves “what-if” results that show the additional index maintenance costs that will be incurred by the update statement.

SELECT queryname, steptext, indexname, maintcost
FROM qcd.querysteps
WHERE queryname = ‘upd_on_t1’
AND maintcost > 0;

The following table shows a sample of the results returned by the above query. The additional maintenance costs of 35 when added to the query costs above of 100 are less than the costs for “query_before” of 200. Therefore the net effect of the simulated join index is positive. This is an indicator to the user that there is a potential improvement to query performance when the simulated materialized view is available. This suggests that the simulated join index be selected for definition as an active materialized view available to all sessions.

| queryname | steptext | indexname | maintcost |
|---|---|---|---|
| upd_on_t1 | Update t1 with all row scan | ji_on_t1 | 35 |

Using the techniques described above to define join indexes in a validation mode within a user session means that the user can perform simulation experiments on materialized views without negatively impacting the workload running on a production system. Another advantage of the techniques described above is the accuracy with regards to estimated costs for both queries and updates. Allowing statistics to be collected on the simulated materialized view improves the accuracy of the associated optimizer cost estimates. Identifying update statements that require maintenance on simulated join indexes and estimating their associated costs helps users make better decisions regarding the overall impact to performance.

The text above describes one or more specific embodiments of a broader invention. The invention also is carried out in a variety of alternative embodiments and thus is not limited to those described here. Those other embodiments are also within the scope of the following claims.

I claim:

1. A method of evaluating a materialized view relating to a base table for a database system, the method comprising:
defining a simulated materialized view for the base table within a user session;
storing the definition for the simulated materialized view in computer memory such that the definition is available only within the user session;
maintaining the definition(s) for one or more active materialized views relating to the base table in computer memory such that the definition(s) is/are available outside the user session; and
invoking an optimizer to evaluate the simulated materialized view within the user session as if the materialized view was available outside the user session.

2. The method of claim 1 further comprising the step of collecting statistics on the simulated materialized view within the user session.

3. The method of claim 2 further comprising the step of collecting statistics on the simulated materialized view within the user session as if the materialized view was available outside the user session.

4. The method of claim 1 further comprising the step of calculating the cost of a query as if the simulated materialized view was defined for the base table.

5. The method of claim 2 further comprising the step of calculating maintenance costs of updates as if the simulated materialized view was defined for the base table.

6. A method of selecting a materialized view relating to a base table for a database system, comprising:
defining a simulated materialized view for the base table within a user session;
storing the definition for the simulated materialized view in computer memory such that the definition is available only within the user session;
maintaining the definition(s) for one or more active materialized views relating to the base table in computer memory such that the definition(s) is/are available outside the user session;
invoking an optimizer to evaluate the simulated materialized view within the user session as if the materialized view was available outside the user session; and
selecting the simulated materialized view on detecting a potential improvement of performance.

7. The method of claim 6 further comprising the step of collecting statistics on the simulated materialized view within the user session.

8. The method of claim 7 further comprising the step of collecting statistics on the materialized view within the user session as if the materialized view was available outside the user session.

9. The method of claim 7 further comprising the step of calculating the cost of the query as if the materialized view was defined for the base table.

10. The method of claim 7 further comprising the step of calculating maintenance costs of updates as if the materialized view was defined for the base table.

11. A system for evaluating a materialized view relating to a base table for a database system, the system comprising:
an index definition module configured to enable a user to define a simulated materialized view for the base table within a user session;
a memory structure maintained in computer memory configured to have stored in it the simulated materialized view such that the definition is available only within the user session;
a dictionary structure maintained in computer memory configured to have stored in it one or more active materialized views relating to the base table such that the definition(s) is/are available outside the user session; and
an optimizer configured to evaluate the simulated materialized view within the user session, as if the materialized view was available outside the user session.

12. The system of claim 11 further configured to enable a user to collect statistics on the simulated materialized view within the user session.

13. The system of claim 12 wherein the statistics are collected within the user session as if the simulated materialized view was available outside the user session.

14. The system of claim 11 further configured to enable a user to calculate the cost of a query as if the simulated materialized view was defined for the base table.

15. The system of claim 11 further configured to enable a user to calculate maintenance costs of updates as if the simulated materialized view was defined for the base table.

16. A system for selecting a materialized view relating to a base table for a database system, the system comprising:
an index definition module configured to enable a user to define a simulated materialized view for the base table within a user session;
a memory structure maintained in computer memory configured to have stored in it the simulated materialized view such that the definition is available only within the user session;
a dictionary structure maintained in computer memory configured to have stored in it one or more active materialized views relating to the base table such that the definition(s) is/are available outside the user session;
an optimizer configured to evaluate the simulated materialized view within the user session as if the materialized view was available outside the user session; and
a performance assessment module enabling a user to select the simulated materialized view on detecting a potential improvement of performance.

17. The system of claim 16 further configured to enable a user to collect statistics on the simulated materialized view within the user session.

18. The system of claim 17 further configured to enable a user to collect statistics on the materialized view within the user session as if the materialized view was available outside the user session.

19. The system of claim 16 further configured to calculate the cost of the query as if the materialized view was defined for the base table.

20. The system of claim 16 further configured to calculate maintenance costs of updates as if the materialized view was defined for the base table.

21. A computer program stored on tangible storage media comprising executable instructions for performing a method of evaluating a materialized view relating to a base table for a database system, the method comprising:
defining a simulated materialized view for the base table within a user session;
storing the definition for the simulated materialized view in computer memory such that the definition is available only within the user session;
maintaining the definition(s) for one or more active materialized views relating to the base table in computer memory such that the definition(s) is/are available outside the user session; and
invoking an optimizer to evaluate the simulated materialized view within the user session as if the materialized view was available outside the user session.

22. The computer program of claim 21, the method further comprising the step of collecting statistics on the simulated materialized view within the user session.

23. The computer program of claim 22, the method further comprising the step of collecting statistics on the simulated materialized view within the user session as if the materialized view was available outside the user session.

24. The computer program of claim 21, the method further comprising the step of calculating the cost of a query as if the simulated materialized view was defined for the base table.

25. The computer program of claim 21, the method further comprising the step of calculating maintenance costs of updates as if the simulated materialized view was defined for the base table.

26. A computer program stored on tangible storage media comprising executable instructions for performing a method of selecting a materialized view relating to a base table for a database system, the method comprising:
defining a simulated materialized view for the base table within a user session;
storing the definition for the simulated materialized view in computer memory such that the definition is available only within the user session;
maintaining the definition(s) for one or more active materialized views relating to the base table in computer memory such that the definition(s) is/are available outside the user session;
invoking an optimizer to evaluate the simulated materialized view within the user session as if the materialized view was available outside the user session; and
selecting the simulated materialized view on detecting a potential improvement of performance.

27. The computer program of claim 26, the method further comprising the step of collecting statistics on the simulated materialized view within the user session.

28. The computer program of claim 27, the method further comprising the step of collecting statistics on the materialized view within the user session as if the materialized view was available outside the user session.

29. The computer program of claim 26, the method further comprising the step of calculating the cost of the query as if the materialized view was defined for the base table.

30. The computer program of claim 26, the method further comprising the step of calculating maintenance costs of updates as if the materialized view was defined for the base table.
